(19) United States
(12) Patent Application Publication
(10) Pub. No.: US 2018/0000046 A1
(43) Pub. Date: Jan. 4, 2018

(54) SWINGZCAT

(71) Applicant: Alan Joseph Kearney, Brampton (CA)

(72) Inventor: Alan Joseph Kearney, Brampton (CA)

(21) Appl. No.: 15/198,875

(22) Filed: Jun. 30, 2016

(51) Int. Cl. A01K 15/02

(52) U.S. Cl. CPC A01K 15/024

(57) ABSTRACT

The utility model belongs to the technical field of pet appliances, particularly relates to and discloses a cat climbing frame. This frame is comprised of a climbing column and resting perch that is suspended from above structures by rope, wire, or chain indoors or outdoors. The hanging height is changeable by adjusting the length of hanging material over the frame. The frame is covered in a variant of cat claw penetrable materials such as carpet, rope or fabric materials. The device satisfies cats need to climb, play, scratch, and perch in elevated places. A key feature is the way cats make the frame move under its hanging location. Cats find this climber very interesting and love to attack it making it swing and twist as well as sleep and play on the upper perch. This movable climbing frame entices cats for active healthy exercise and provides endless entertainment for cats owners.

Cats are natural climbers and like to climb high. Cat climbing frames typically have a base pedestal that requires a large footprint and/or brackets for vertical support. This new cat climbing frame requires no base, brackets or floor space and is suspended from above by rope, wire or chain indoors or outdoors. This climber can be hung to many structures including but not limited to ceilings, deck structures, tree branches etc. The cat climbing frame is hung under one or two mounting location where the device is free to swing, rock, and rotate. The invention is comprised of a vertical column and upper platform both covered in claw penetrable materials with hanging materials. Both the vertical column and top platform can be made using a variety of materials like wood, plastic or cardboard. The vertical column can be round, square or other. The top platform and column can be made to numerous decorative designs.

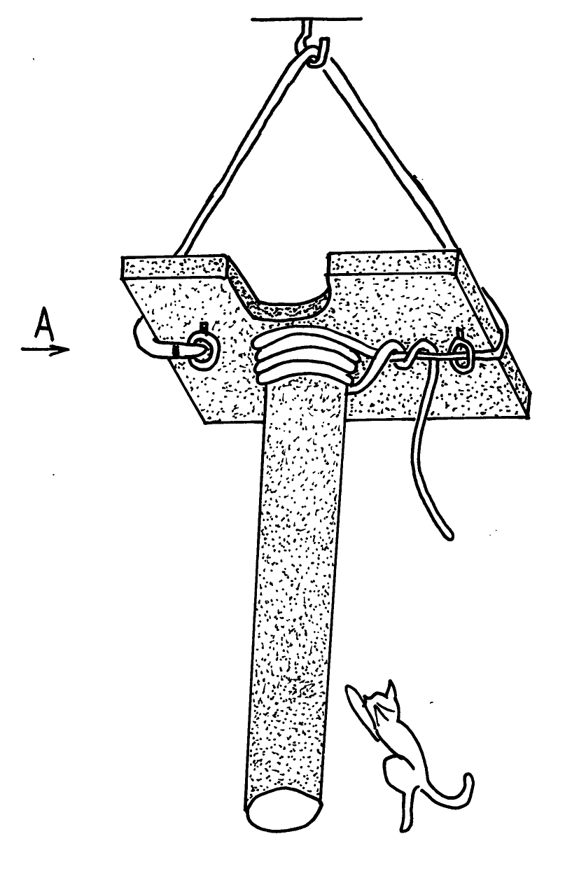

FIG. 1 is a pictorial drawing of the cat climbing frame suspended from a ceiling using a single hook and rope. The climbing frame is comprised of a vertical column and top platform perch both covered in carpet. In this illustration one end of the rope is fixed to an eye-bolt under the top platform's left side and the rope is hung over a ceiling hook and threaded through an eye-bolt under the platform's right side. The rope is wrapped several turns around the vertical column and looping the loose end of rope around itself under the platform. Hanging height changes are easily made by adjusting the length of rope above the top platform. Wrapping rope around the vertical column only a few times provides good non-slip traction, securely holding the climbing frame into a desired height position. An alternate hanging method using no eye bolts by threading rope through holes in platform can be utilized.

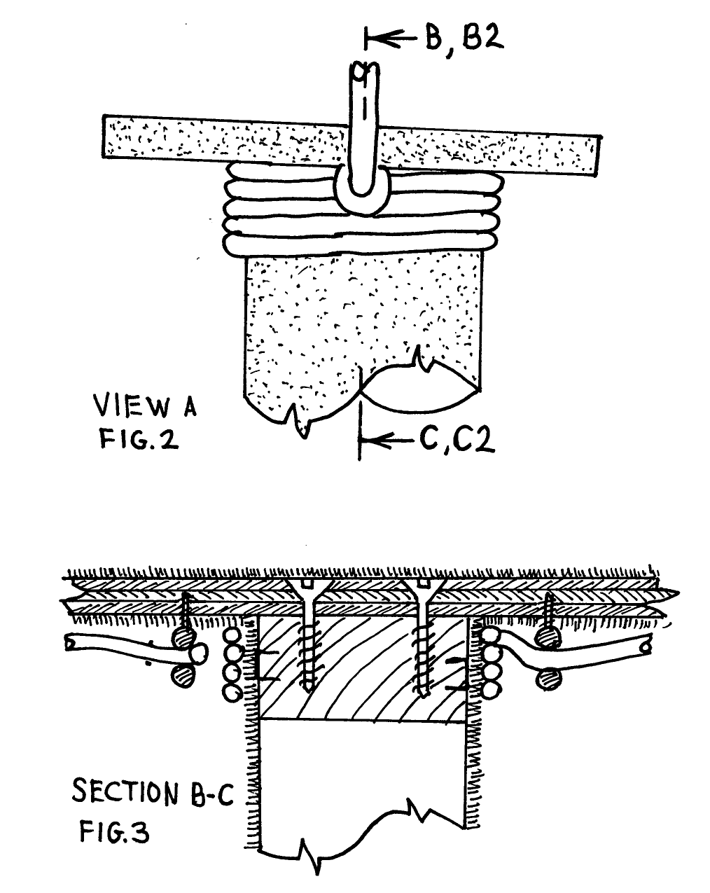

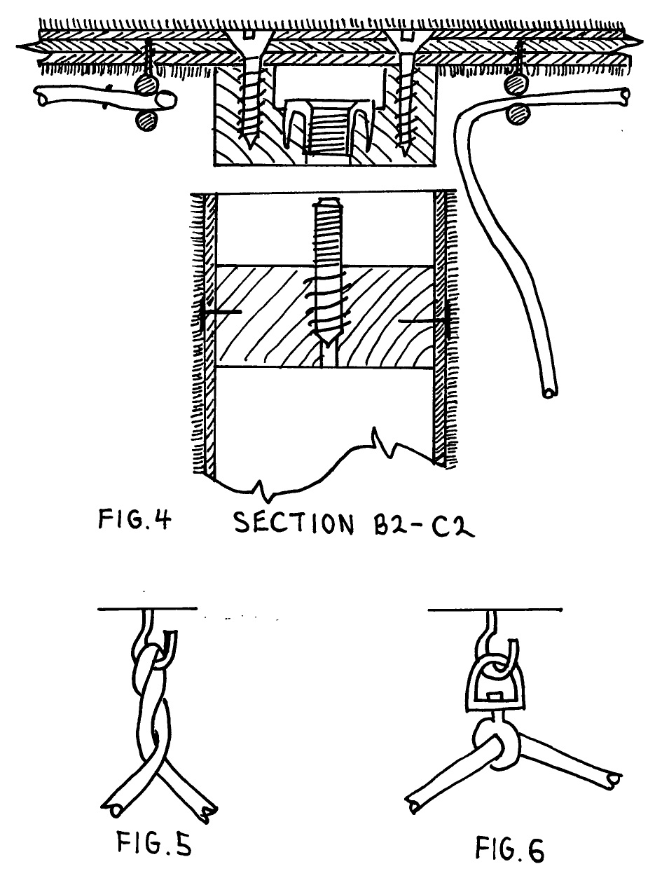

FIG. 2 labeled VIEW A illustrates a partial side elevation of the cat climbing frame. This drawing indicates two sectional views B-C and B2-C2 in the same cut plane illustrating two alternate construction assemblies shown in FIGS. 3 and 4. These assembly are strong enough to withstand forces applied by rambunctious cats. The construction and coupling methods illustrated are not limited to these examples.

FIG. 3 labeled SECTION B-C. Illustrates an assembly design for fixing the vertical climbing column to the top platform. In this example the vertical column is carpet formed into a cylindrical shape with a hardwood doweling glued and stapled into top portion of column. The column is fixed to top plate using wood screws and can be glued to form a permanent bond.

FIG. 4 labeled SECTION B2-C2 Illustrates a detachable coupling assembly between the vertical column and platform, show detached for clarity. Other construction methods for fixing the platform and column can also be utilized. In this example the upper platform has a hardwood piece glued and screwed permanently. This hard wood piece has a pronged tee-nut fixed inside the bottom of a counter bore. In this example the vertical column is made using tubing, covered in carpet and has a piece of hardwood fixed inside near the top of the column. The hardwood is glued and screwed, or nailed, or stapled permanently. This piece of hardwood has a hanger-bolt positioned so it does not protrude outside of tubing. The hanger-bolt has both wood threads and machine threads on opposing sides. The machine thread of the hanger-bolt engages into tee-nut in platform. The vertical column is threaded onto to platform hand tight providing friction between the two wood mating surfaces. Both the tee-nut and hanger-bolt are commonly found in hardware suppliers.

FIG. 5 Illustrates the twisting and rotation action of rope for hanging a cat climbing frame by single hook.

FIG. 6 illustrates a swivel used with rope to increase the rotating action for hanging of the cat climbing frame.

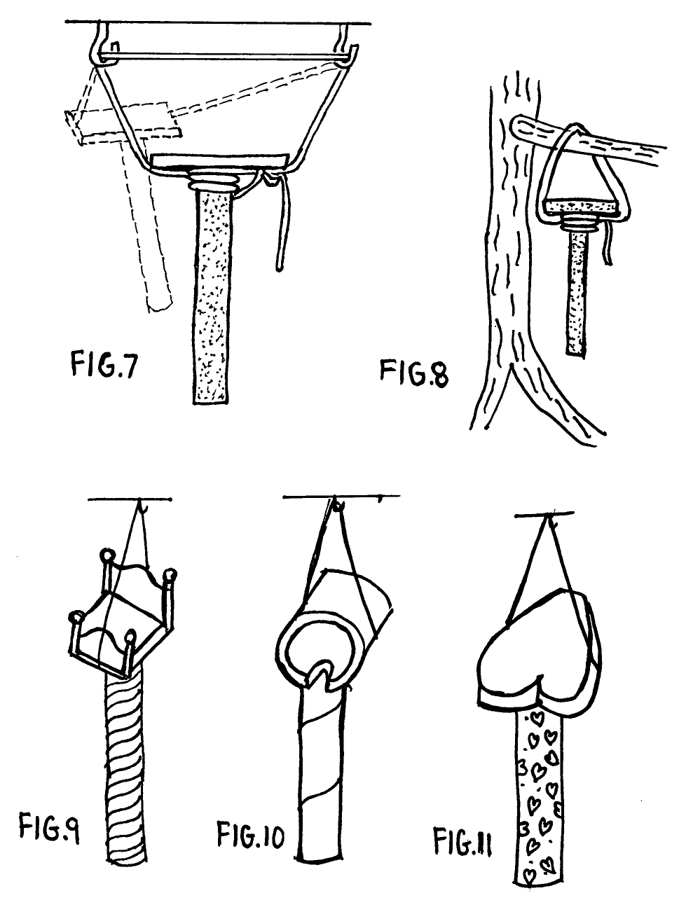

FIG. 7 illustrates a cat climbing frame suspended under at two mounting locations. This hanging method changes the movable action of the climbing frame. The hanging height of the climbing frame is easily changeable by adjusting the length of rope above platform.

FIG. 8 illustrates the cat climbing frame hung over a tree branch, without additional hardware.

FIG. 9, 10, 11 illustrations demonstrates various attractive decorative models and themes but the content of the invention is not limited to theses examples. The top platform perch portion can be of numerous shapes and sizes using a variety of materials. Easy access to the top section for cats climbing through holes or cutout may or may not utilized.

### SUMMARY

The utility model invention named “SWINGZCAT” is a pet appliance for cats to climb, play, scratch and rest. The Swingzcat is an attractive and decorative cat climbing frame that is suspended from above at a single or double mounting location. This frame is comprised of a climbing post and resting perch covered with claw penetrable material and hung by rope, wire or chain. The climbing frame is free to swing, rock, twist and rotate. The cat climbing frame entices cat for active exercise and provides endless entertainment for cats and people watching them play and rest.

1. Claim that the cat climbing frame is basically comprised of a vertical climbing column and upper resting perch that is suspended from above and has no base or pedestal. This frame is hung from above structures by rope, wire, or chain at a single or double mounted location. This frame is free to move from under its mounting location by swinging, rocking, twisting and rotating.

2. Claim that the cat climbing frame of claim 1, is to be suspended from above to a variant of structures indoors and outdoors including but not limited to ceilings, decks, trees, fences etc. Using a variant of hanging materials but not limited to rope, wire, chain. The hanging height can fixed or can be adjustable.

3. Claim that the vertical column of the climbing frame in claim 1, can be made in various shapes round, square or other shapes, can be made using variant of materials but not limited to carpet, fabric, rope, wood, plastic, cardboard or composition of these and can be solid or hollow.

4. A number of embodiments of the climbing frame in claim 1 have been illustrated. Claim that numerous various decorative modifications and themes may be made without departing the spirit and scope of the invention.

5. Composition for joining the vertical column and top platform can be in variations for the climbing frame in claim 1. This union can be permanent or detachable. Illustrated in FIG. 3 where wood doweling is fixed to topplate using wood screws and glued if desired for a permanent joint. The wood doweling is glued, screwed, stapled or nailed inside vertical column.

6. Composition for joining the vertical column and top platform can be in variations for the climbing frame in claim 1. Illustrated in FIG. 4 the platform has a wood doweling glued and screwed and has a tee-nut fixed inside a counter bore. The detachable vertical column has wood doweling near or at the top and is glued and nailed, or stapled and has a full threaded metal stud with wood and machine threads on opposing sides. The column is threaded onto to platform hand tight providing friction between the two wood mating surfaces.
